(19) United States
(12) Patent Application Publication
(10) Pub. No.: US 2009/0235505 A1
(43) Pub. Date: Sep. 24, 2009

(54) HEM FLANGE CONTROL ROLLER

(75) Inventors: James Toeniskoetter, Rochester Hills, MI (US); Ranganathan Padmanabhan, Coimbatore (IN)

Correspondence Address: FILDES & OUTLAND, P.C., 20916 MACK AVE., SUITE 2, GROSSE POINTE WOODS, MI, 48236, US

(73) Assignee: HIROTEC AMERICA, INC., Auburn Hills, MI (US)

(21) Appl. No.: 12/400,115

(22) Filed: Mar. 9, 2009

Related U.S. Application Data
(60) Provisional application No. 61/070,552, filed on Mar. 24, 2008.

(51) Int. Cl. B23P 11/00; B21D 5/01

(52) U.S. Cl. 29/243.58; 72/214

(57) ABSTRACT

A method of roller hemming an inner panel and an outer panel includes providing a hem roller having an angled roller hemming surface, and adjusting a hem flange line by moving the hem roller axially and generally parallel to an anvil support surface.

### CROSS REFERENCE TO RELATED APPLICATION

This application claims the priority of U.S. Provisional Application No. 61/070,552 filed Mar. 24, 2008.

### TECHNICAL FIELD

This invention relates to roller hemming, such as roller hemming of wheelhouse openings and other vehicle closure panel assemblies.

### BACKGROUND OF THE INVENTION

It is known in the art relating to roller hemming to hold a hem roller on a guide surface of a lower die which supports a set of panels for hemming. As shown in FIG. 34, a hem roller 20 for hemming a workpiece W is rotatably connected to a robot arm 22 having a predetermined traveling path. A die/anvil 24 is provided generally below the hem roller 20 and has a guide surface 26 formed by cutting a corner thereof in a descending manner. The workpiece W is positioned between the hem roller 20 and the anvil 24. The workpiece W includes an outer panel WO and an inner panel WI. The outer panel WO has a peripheral edge bent substantially at right angles toward the inner panel WI to form an upturned edge WE, and the inner panel WI has a peripheral edge arranged along the inside of the upturned edge WE. To perform a pre-hem operation on the workpiece W, the guide surface 26 holds the hem roller 20 in a first position such that when the hem roller is moved along the guide surface, the hem roller abuts against the upturned edge WE of the outer panel WO at a desired distance from the bend in the outer panel. The guide surface 26 thereby controls the position of the hem roller 20 relative to the panels during hemming.

However, it is difficult to control and adjust the hem flange line when using this conventional method. Any build-up or wearing away of the guide surface 26 will undesirably change the position of the hem flange line as indicated by double-sided arrows in FIG. 34. In order to adjust the hem flange line, the guide surface 26 must be machined or altered in another mechanical manner. Further, the hem flange line cannot be adjusted in-process because it is predetermined by the configuration of the guide surface 26. Moreover, any variation in the width of the panels WO and WI may affect the position of the hem flange line, and the position of the hem roller 20 must be corrected by machining or building-up the guide surface 26.

### SUMMARY OF THE INVENTION

The present invention provides a roller hemming apparatus and method that allows for simple and easy adjustment of the hem flange line by moving a hem roller axially and generally parallel to an anvil surface.

One or two hem rollers may be used to perform pre-hem operations, and one hem roller is used to perform final hem operations. In one embodiment, a roller hemming head includes three hem rollers, one for forming a 60 degree pre-hem, one for forming a 30 degree pre-hem, and one for forming a flat final hem. A sight line between the hem rollers and an edge of the anvil provides for accurate robot programming of the position of the hem rollers and control of the hem flange line.

A method of roller hemming an inner panel and an outer panel in accordance with the present invention includes the steps of providing a hem roller having an angled roller hemming surface, and adjusting a hem flange line by moving the hem roller axially and generally parallel to an anvil support surface.

More particularly, a method of roller hemming in accordance with the present invention includes disposing an inner panel and an outer panel on a support surface of an anvil. Pre-hem operations are performed, the pre-hem operations including aligning a control surface of a pre-hem roller with an edge of the anvil along a sight line defined by the anvil edge by moving the pre-hem roller axially along its axis and generally parallel to the anvil support surface, whereby a location of a hem flange line extending from an angular bend in the outer panel is set, and rotating the pre-hem roller along the anvil support surface in alignment with the sight line such that the angled roller hemming surface of the pre-hem roller contacts the outer panel to form an angled pre-hem bend in the outer panel. After the pre-hem operations, final hem operations are performed. The final hem operations include aligning a control surface of a final hem roller with the anvil edge along the sight line by moving the final hem roller axially along its axis and generally parallel to the anvil support surface, and rotating the final hem roller along the anvil support surface in alignment with the sight line such that the final hem roller contacts the outer panel to form a final hem between the inner and outer panels.

The pre-hem operations may include aligning a control surface of a first pre-hem roller with an edge of the anvil along a sight line defined by the anvil edge by moving the first pre-hem roller axially along its axis and generally parallel to the anvil support surface, whereby a location of a hem flange line extending from an angular bend in the outer panel is set; rotating the first pre-hem roller along the anvil support surface in alignment with the sight line to form an angled pre-hem bend in the outer panel; aligning a control surface of a second pre-hem roller with an edge of the anvil along a sight line defined by the anvil edge by moving the pre-hem roller axially along its axis and generally parallel to the anvil support surface, whereby a location of a hem flange line extending from an angular bend in the outer panel is set; and rotating the second pre-hem roller along the anvil support surface in alignment with the sight line to form an angled pre-hem bend in the outer panel.

Alternatively, the pre-hem operations may include aligning a control surface of a pre-hem roller with an edge of the anvil along a sight line defined by the anvil edge by moving the first pre-hem roller axially along its axis and generally parallel to the anvil support surface, whereby a location of a hem flange line extending from an angular bend in the outer panel is set; pivoting the pre-hem roller about a crown of the pre-hem roller to adjust the disposition of a angled surface of the pre-hem roller relative to the anvil support surface; rotating the pre-hem roller along the anvil support surface to form an angled pre-hem bend in the outer panel; pivoting the pre-hem roller about the crown to align the control surface of the pre-hem roller with the anvil edge; and rotating the pre-hem roller along the anvil support surface in alignment with the sight line to form an angled pre-hem bend in the outer panel.

A rope hem may be formed between the inner and outer panels. Alternatively, a flat hem may be formed between the inner and outer panels.

An apparatus for roller hemming an inner panel and an outer panel includes an anvil having a support surface for supporting the inner and outer panels and an edge adjacent the support surface. A hem roller is rotatable about an axis and has a roller hem surface for engaging the outer panel to effect a hem operation and a control surface for aligning the hem roller. The control surface is aligned with the anvil edge by moving the hem roller axially along the axis and generally parallel to the anvil support surface.

The hem roller surface for engaging the outer panel may be an angled surface for effecting a pre-hem bend in the outer panel. The angled surface may be a 30 degree angled surface or a 60 degree angled surface, although the roller may have any angle depending on the product and/or flange open angle of the flange to be hemmed. Alternatively, the hem roller surface for engaging the outer panel may be a flat surface for effecting a final hem bend in the outer panel. The roller may include a crown engagable with the anvil support surface, the roller being pivotable about the crown relative to the anvil support surface.

These and other features and advantages of the invention will be more fully understood from the following detailed description of the invention taken together with the accompanying drawings.

### BRIEF DESCRIPTION OF THE DRAWINGS

In the drawings:

FIG. 1 is a side view of a 60 degree angle pre-hem roller performing a first hemming pass for a rope hem in accordance with a first embodiment of the present invention;

FIG. 2 is a side view of a 30 degree angle pre-hem roller performing a second hemming pass in accordance with the first embodiment;

FIG. 3 is a side view of a rope hem final hem roller performing a third hemming pass in accordance with the first embodiment;

FIG. 4 is a side view of a 30 degree angle pre-hem roller performing a 60 degree pre-hem operation for a rope hem in accordance with a second embodiment of the present invention;

FIG. 5 is a side view of the 30 degree angle pre-hem roller performing a 30 degree pre-hem operation in accordance with the second embodiment;

FIG. 6 is a side view of a rope hem final hem roller performing a final hemming pass in accordance with the second embodiment;

FIG. 7 is a side view of a 60 degree angle pre-hem roller performing a first hemming pass for a flat hem in accordance with a third embodiment of the present invention;

FIG. 8 is a side view of a 30 degree angle pre-hem roller performing a second hemming pass in accordance with the third embodiment;

FIG. 9 is a side view of a flat final hem roller performing a third hemming pass in accordance with the third embodiment;

FIG. 10 is a side view of a 30 degree angle pre-hem roller performing a 60 degree pre-hem operation for a flat hem in accordance with a fourth embodiment of the present invention;

FIG. 11 is a side view of the 30 degree angle pre-hem roller performing a 30 degree pre-hem operation in accordance with the fourth embodiment;

FIG. 12 is a side view of a flat final hem roller performing a final hemming pass in accordance with the fourth embodiment;

FIG. 13 is a side view of a 60 degree angle pre-hem roller performing a first hemming pass for a rope hem in accordance with a fifth embodiment of the present invention;

FIG. 14 is a side view of a 30 degree angle pre-hem roller performing a second hemming pass in accordance with the fifth embodiment;

FIG. 15 is a side view of a rope hem final hem roller performing a third hemming pass in accordance with the fifth embodiment;

FIG. 16 is a side view of a 60 degree angle pre-hem roller performing a first hemming pass for a flat hem in accordance with a sixth embodiment of the present invention;

FIG. 17 is a side view of a 30 degree angle pre-hem roller performing a second hemming pass in accordance with the sixth embodiment;

FIG. 18 is a side view of a flat final hem roller performing a third hemming pass in accordance with the sixth embodiment;

FIG. 19 is a side view of a 60 degree angle pre-hem roller performing a first hemming pass for a flat hem in accordance with a seventh embodiment of the present invention;

FIG. 20 is a side view of a 30 degree angle pre-hem roller performing a second hemming pass in accordance with the seventh embodiment;

FIG. 21 is a side view of a flat final hem roller performing a third hemming pass in accordance with the seventh embodiment;

FIG. 22 is a side view of a 60 degree angle pre-hem roller performing a first hemming pass for a flat hem in accordance with a eighth embodiment of the present invention;

FIG. 23 is a side view of a 30 degree angle pre-hem roller performing a second hemming pass in accordance with the eighth embodiment;

FIG. 24 is a side view of a flat final hem roller performing a third hemming pass in accordance with the eighth embodiment;

FIG. 25 is a side view of a 60 degree angle pre-hem roller performing a first hemming pass for a flat hem in accordance with a ninth embodiment of the present invention;

FIG. 26 is a side view of a 30 degree angle pre-hem roller performing a second hemming pass in accordance with the ninth embodiment;

FIG. 27 is a side view of a flat final hem roller performing a third hemming pass in accordance with the ninth embodiment;

FIG. 28 is a side view of a 60 degree angle pre-hem roller performing a first hemming pass for a rope hem in accordance with a tenth embodiment of the present invention;

FIG. 29 is a side view of a 30 degree angle pre-hem roller performing a second hemming pass in accordance with the tenth embodiment;

FIG. 30 is a side view of a rope hem final hem roller performing a third hemming pass in accordance with the tenth embodiment;

FIG. 31 is a side view of a 60 degree angle pre-hem roller performing a first hemming pass for a rope hem in accordance with a eleventh embodiment of the present invention;

FIG. 32 is a side view of a 30 degree angle pre-hem roller performing a second hemming pass in accordance with the eleventh embodiment;

FIG. 33 is a side view of a rope hem final hem roller performing a third hemming pass in accordance with the eleventh embodiment; and

FIG. 34 is a side view of a prior art flat hem roller performing a pre-hem operation by moving along a machined guide surface of a die.

### DETAILED DESCRIPTION OF THE INVENTION

Referring now to the drawings in detail, a hem flange control roller in accordance with the present invention controls the position of a hem flange line by moving along its axis relative to and generally parallel to a support surface of an anvil. A sight line exists between the hem flange control roller and the anvil surface for robot programming of the position of the roller.

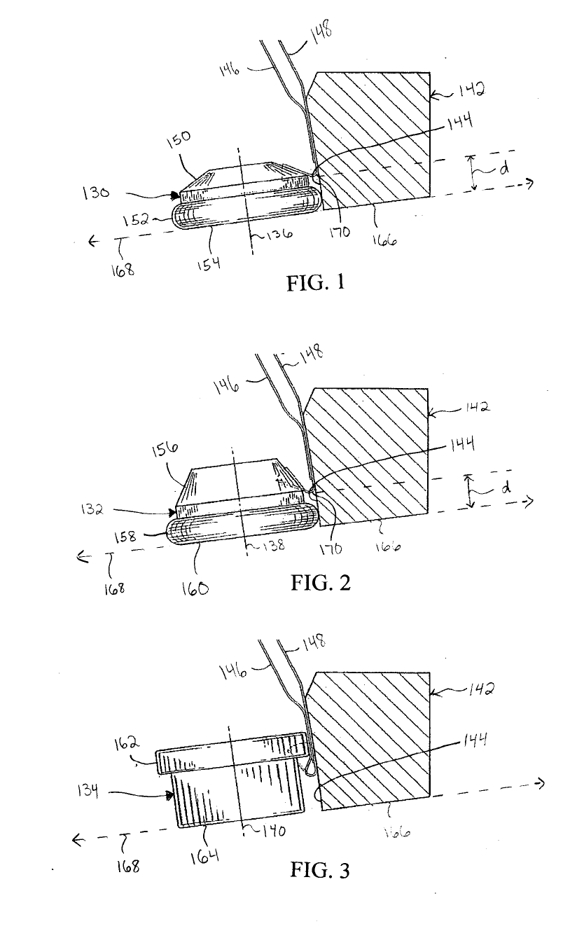

In a first embodiment shown in FIGS. 1 through 3, a first pre-hem roller 130, a second pre-hem roller 132, and a final hem roller 134 may be rotatably mounted about their respective axes 136, 138, 140 to a roller hemming head which is carried by a programmable multi-axis robotic arm (not shown). An anvil 142 having a support surface 144 supports an inner panel 146 and outer panel 148 for hemming.

The hem rollers 130, 132, 134 are configured for forming a rope hem in the inner and outer panels 146, 148. Each hem roller is dedicated for a specific roller hem pass. The first pre-hem roller 130 (FIG. 1) includes a 60 degree angled surface 150 for forming a 60 degree pre-hem flange bend in the outer panel 148 during a first hem pass, a crown 152 for engagement with the anvil support surface 144, and a control surface 154 for aligning the roller as described in more detail below. Similarly, the second pre-hem roller 132 (FIG. 2) includes a 30 degree angled surface 156 for forming a 30 degree pre-hem flange bend in the outer panel 148 during a second hem pass, a crown 158 for engagement with the anvil support surface 144, and a control surface 160. It should be understood, however, that the pre-hem rollers may have any angle depending on the product formed by the inner and outer panels and/or the open angle of the flange to be hemmed. For example, the pre-hem rollers may have 80 degree and 40 degree angled surfaces, respectively. The following description discusses 60 degree and 30 degree angled pre-hem rollers, but the present invention is not limited to these specific dimensions. The final hem roller 134 (FIG. 3) includes a flat surface 162 for bending the outer panel 148 against the inner panel 146 during a third hem pass, and a control surface 164.

The support surface 144 of the anvil 142 assists in controlling the pre-hemming condition by directing pressure on the anvil 142 and having a tight control on the hem flange. The anvil support surface 144 may be made of the same material as the pre-hem rollers 130, 132, and in this case the pre-hem roller crowns 152, 158 and the anvil support surface 144 may have different Rockwell hardness values. Alternatively, the support surface 144 may have an inserted, replaceable material that places the wear condition directly on the roller and that can be easily replaced. In yet another embodiment, polymer material(s) or high strength steel material(s) may be used to overcome the wear issues with respect to the anvil and rollers.

The control surface 154 of the first pre-hem roller 130 is aligned with an edge 166 of the anvil 142 along a straight sight line 168. The alignment of the control surface 154 with the anvil edge 166 controls the distance d between the anvil edge 166 and the hem flange bend 170 in the outer panel 148, thereby determining the position of the hem flange line. To adjust the position of the hem flange line, the first pre-hem roller 130 is moved axially along its axis 136 generally parallel to the anvil surface 144, which in turn varies the position of the roller's angled hemming surface 150 relative to the outer panel 148. Similarly, the control surface 160 of the second pre-hem roller 132 is aligned with the anvil edge 166 along the straight sight line 168, and the control surface 164 of the final hem roller 134 is aligned with the anvil edge 144 along the straight sight line 168.

To form a rope hem between the inner and outer panels 146, 148, the robotic arm presses the first pre-hem roller 130 against the anvil support surface 144 and executes a first pass by moving the first pre-hem roller along a path in which the control surface 154 is aligned with the anvil edge 166, thereby forming a 60 degree pre-hem flange bend in the outer panel (FIG. 1). The robotic arm then presses the second pre-hem roller 132 against the anvil support surface 144 and executes a second pass by moving the second pre-hem roller along a path in which the control surface 160 is aligned with the anvil edge 166, thereby forming a 30 degree pre-hem flange bend in the outer panel (FIG. 2). The robotic arm then completes the rope hem by pressing the flat surface 162 of the final hem roller 134 against the outer panel 148 and executing a third pass by moving the final hem roller along a path in which the control surface 164 is aligned with the anvil edge 166 (FIG. 3).

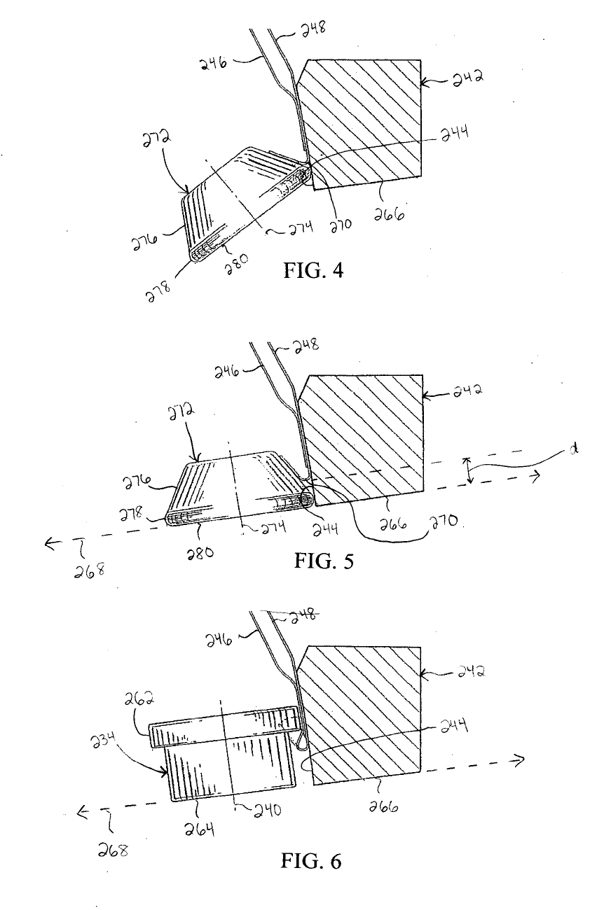

In a second embodiment shown in FIGS. 4 through 6, a single pre-hem roller 272 and a final hem roller 234 may be rotatably mounted about their respective axes 274, 240 to a roller hemming head which is carried by a programmable multi-axis robotic arm (not shown). An anvil 242 having a support surface 244 supports an inner panel 246 and outer panel 248 for hemming.

The hem rollers 234, 272 are configured for forming a rope hem in the inner and outer panels 246, 248. The pre-hem roller 272 is utilized for first and second hem passes (pre-hem operations) and the final hem roller 234 is utilized for a third hem pass (final hem operation). The pre-hem roller 272 (FIGS. 4 and 5) includes a 30 degree angled surface 276 for forming 60 and 30 degree pre-hem flange bends in the outer panel 248 during the first and second hem pass, a crown 278 for engagement with the anvil support surface 244, and a control surface 280 for aligning the roller. The final hem roller 234 (FIG. 6) includes a flat surface 262 for bending the outer panel 248 against the inner panel 246 during the third hem pass, and a control surface 264.

The control surface 280 of the pre-hem roller 272 is aligned with an edge 266 of the anvil 242 along a straight sight line 268 (FIG. 5). The alignment of the control surface 280 with the anvil edge 266 controls the distance d between the anvil edge 266 and the hem flange bend 270 in the outer panel 248, thereby determining the position of the hem flange line. To adjust the position of the hem flange line, the pre-hem roller 272 is moved axially along its axis 274 generally parallel to the anvil surface 244, which in turn varies the position of the roller's angled hemming surface 276 relative to the outer panel 248. Similarly, the control surface 264 of the final hem roller 234 is aligned with the anvil edge 266 along the straight sight line 268.

To form a rope hem between the inner and outer panels 246, 248, the robotic arm first presses the pre-hem roller 272 against the anvil support surface 244 and aligns the control surface 280 with the anvil edge 266 along the sight line 268 (FIG. 5). The robotic arm is then programmed to move the pre-hem roller 272 in a path along the sight line 268. To begin hemming the panels 246, 248, the robotic arm presses the pre-hem roller 272 against the anvil support surface 244 and pivots the pre-hem roller about the crown 278 until a desired angle is obtained between the roller's angled surface 276 and the anvil support surface 244. In this case, the pre-hem roller 272 is pivoted 30 degrees about the crown 278 in order to pre-hem a 60 degree bend in the outer panel 248. The robotic arm executes a first pass by moving the pivoted pre-hem roller 272 along the preprogrammed path, thereby forming a 60 degree pre-hem flange bend in the outer panel 248 (FIG. 4). The robotic arm then returns the pre-hem roller 272 into a position in which the control surface 280 is aligned with the anvil edge 266 by pivoting the pre-hem roller 30 degrees in the opposite direction. The robotic arm executes a second pass by moving the pre-hem roller 272 along the preprogrammed path, thereby forming a 30 degree pre-hem flange bend in the outer panel 248 (FIG. 5). The robotic arm then completes the rope hem by pressing the flat surface 262 of the final hem roller 234 against the outer panel 248 and executing a third pass by moving the final hem roller along a path in which the control surface 264 is aligned with the anvil edge 266 (FIG. 6).

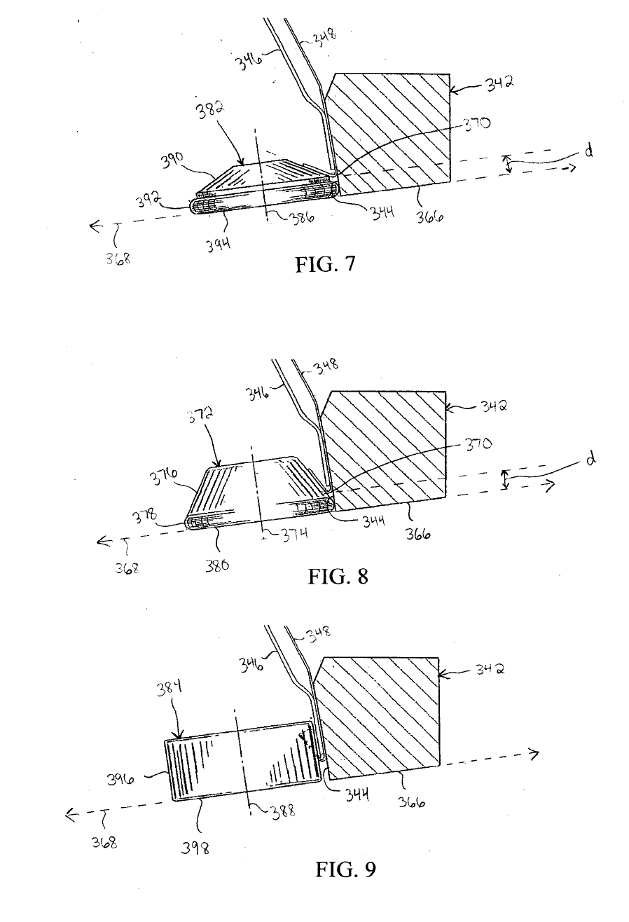

In a third embodiment shown in FIGS. 7 through 9, a first pre-hem roller 382, a second pre-hem roller 372, and a final hem roller 384 may be rotatably mounted about their respective axes 386, 374, 388 to a roller hemming head which is carried by a programmable multi-axis robotic arm (not shown). An anvil 342 having a support surface 344 supports an inner panel 346 and outer panel 348 for hemming.

The hem rollers 372, 382, 384 are configured for forming a flat hem in the inner and outer panels 346, 348. Each hem roller is dedicated for a specific roller hem pass. The first pre-hem roller 382 (FIG. 7) includes a 60 degree angled surface 390 for forming a 60 degree pre-hem flange bend in the outer panel 348 during a first hem pass, a crown 392 for engagement with the anvil support surface 344, and a control surface 394 for aligning the roller. Similarly, the second pre-hem roller 372 (FIG. 8) includes a 30 degree angled surface 376 for forming a 30 degree pre-hem flange bend in the outer panel 348 during a second hem pass, a crown 378 for engagement with the anvil support surface 344, and a control surface 380. The final hem roller 384 (FIG. 9) includes a flat surface 396 for bending the outer panel 348 against the inner panel 346 during a third hem pass, and a control surface 398.

The control surface 394 of the first pre-hem roller 382 is aligned with an edge 366 of the anvil 342 along a straight sight line 368. The alignment of the control surface 394 with the anvil edge 366 controls the distance d between the anvil edge 366 and the hem flange bend 370 in the outer panel 348, thereby determining the position of the hem flange line. To adjust the position of the hem flange line, the first pre-hem roller 382 is moved axially along its axis 386 generally parallel to the anvil surface 344, which in turn varies the position of the roller's angled hemming surface 390 relative to the outer panel 348. Similarly, the control surface 380 of the second pre-hem roller 372 is aligned with the anvil edge 366 along the straight sight line 368, and the control surface 398 of the final hem roller 384 is aligned with the anvil edge 366 along the straight sight line 368.

To form a flat hem between the inner and outer panels 346, 348, the robotic arm presses the first pre-hem roller 382 against the anvil support surface 344 and executes a first pass by moving the first pre-hem roller along a path in which the control surface 394 is aligned with the anvil edge 366, thereby forming a 60 degree pre-hem flange bend in the outer panel 348 (FIG. 7). The robotic arm then presses the second pre-hem roller 372 against the anvil support surface 344 and executes a second pass by moving the second pre-hem roller along a path in which the control surface 380 is aligned with the anvil edge 366, thereby forming a 30 degree pre-hem flange bend in the outer panel 348 (FIG. 8). The robotic arm then completes the flat hem by pressing the flat surface 396 of the final hem roller 384 against the outer panel 348 and executing a third pass by moving the final hem roller along a path in which the control surface 398 is aligned with the anvil edge 366 (FIG. 9).

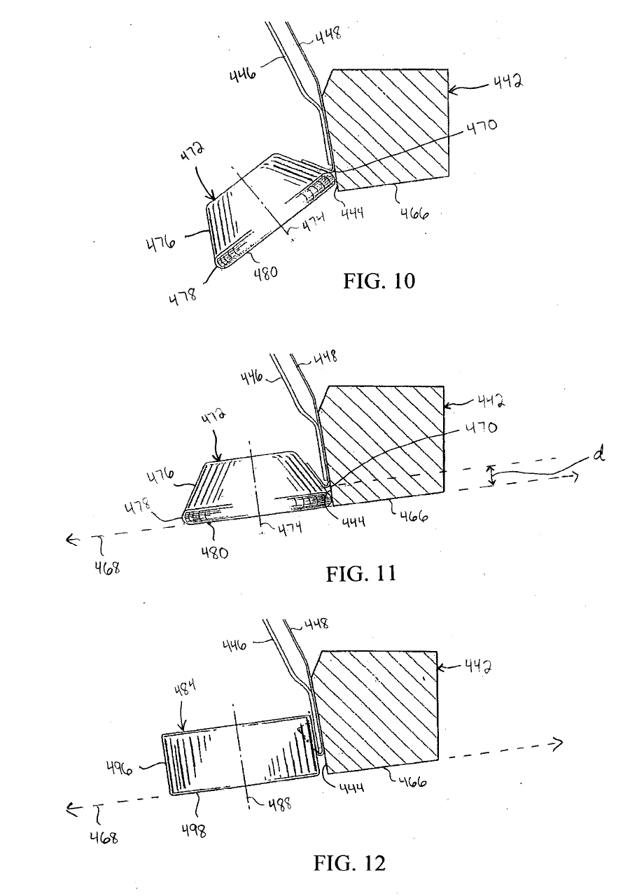

In a fourth embodiment shown in FIGS. 10 through 12, a single pre-hem roller 472 and a final hem roller 484 may be rotatably mounted about their respective axes 474, 488 to a roller hemming head which is carried by a programmable multi-axis robotic arm (not shown). An anvil 442 having a support surface 444 supports an inner panel 446 and outer panel 448 for hemming.

The hem rollers 472, 484 are configured for forming a flat hem in the inner and outer panels 446, 448. The pre-hem roller 472 is utilized for first and second hem passes (pre-hem operations) and the final hem roller 484 is utilized for a third hem pass (final hem operation). The pre-hem roller 472 (FIGS. 10 and 11) includes a 30 degree angled surface 476 for forming 60 and 30 degree pre-hem flange bends in the outer panel 448 during the first and second hem pass, a crown 478 for engagement with the anvil support surface 444, and a control surface 480 for aligning the roller. The final hem roller 484 (FIG. 12) includes a flat surface 496 for bending the outer panel 448 against the inner panel 446 during the third hem pass, and a control surface 498.

The control surface 480 of the pre-hem roller 472 is aligned with an edge 466 of the anvil 442 along a straight sight line 468 (FIG. 11). The alignment of the control surface 480 with the anvil edge 466 controls the distance d between the anvil edge 466 and the hem flange bend 470 in the outer panel 448, thereby determining the position of the hem flange line. To adjust the position of the hem flange line, the pre-hem roller 472 is moved axially along its axis 474 generally parallel to the anvil surface 444, which in turn varies the position of the angled hemming surface 476 relative to the outer panel 448. Similarly, the control surface 498 of the final hem roller 484 is aligned with the anvil edge 466 along a straight sight line 468.

To form a flat hem between the inner and outer panels 446, 448, the robotic arm first presses the pre-hem roller 472 against the anvil support surface 444 and aligns the control surface 480 with the anvil edge 466 along the sight line 468 (FIG. 11). The robotic arm is then programmed to move the pre-hem roller 472 in a path along the sight line 468. To begin hemming the panels 446, 448, the robotic arm then presses the pre-hem roller 472 against the anvil support surface 444 and pivots the pre-hem roller about the crown 478 until a desired angle is obtained between the roller's angled surface 476 and the anvil support surface 444. In this case, the pre-hem roller is pivoted 30 degrees about the crown 478 in order to pre-hem a 60 degree bend in the outer panel 448. The robotic arm executes a first pass by moving the pivoted pre-hem roller 472 along the preprogrammed path, thereby forming a 60 degree pre-hem flange bend in the outer panel 448 (FIG. 10). The robotic arm then returns the pre-hem roller 472 into a position in which the control surface 480 is aligned with the anvil edge 466 by pivoting the pre-hem roller 30 degrees in the opposite direction. The robotic arm executes a second pass by moving the pre-hem roller 472 along the preprogrammed path, thereby forming a 30 degree pre-hem flange bend in the outer panel 448 (FIG. 11). The robotic arm then completes the flat hem by pressing the flat surface 496 of the final hem roller 484 against the outer panel 448 and executing a third pass by moving the final hem roller along a path in which the control surface 498 is aligned with the anvil edge 466 (FIG. 12).

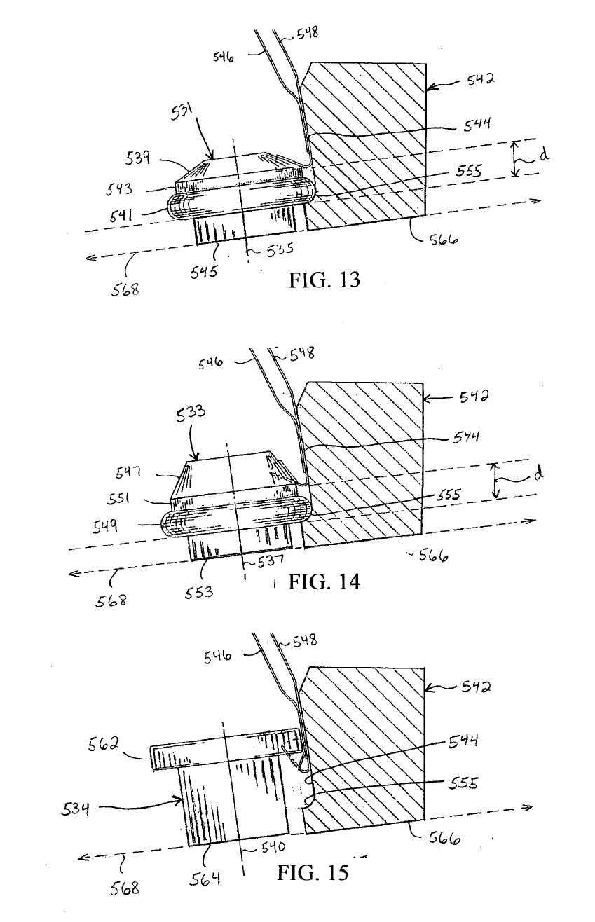

In a fifth embodiment shown in FIGS. 13 through 15, a first pre-hem roller 531, a second pre-hem roller 533, and a final hem roller 534 may be rotatably mounted about their respective axes 535, 537, 540 to a roller hemming head which is carried by a programmable multi-axis robotic arm (not shown). An anvil 542 having a support surface 544 supports an inner panel 546 and outer panel 548 for hemming.

The hem rollers 531, 533, 534 are configured for forming a rope hem in the inner and outer panels 546, 548. Each hem roller is dedicated for a specific roller hem pass. The first pre-hem roller 531 (FIG. 13) includes a 60 degree angled surface 539 for forming a 60 degree pre-hem flange bend in the outer panel 548 during a first hem pass, a crown 541 for engagement with the anvil support surface 544, a cylindrical relief 543, and a control surface 545 for aligning the roller. Similarly, the second pre-hem roller 533 (FIG. 14) includes a 30 degree angled surface 547 for forming a 30 degree pre-hem flange bend in the outer panel 548 during a second hem pass, a crown 549 for engagement with the anvil support surface 544, a cylindrical relief 551, and a control surface 553. The final hem roller 534 (FIG. 15) includes a flat surface 562 for bending the outer panel 548 against the inner panel 546 during a third hem pass, and a control surface 564.

The control surface 545 of the first pre-hem roller 531 is aligned with an edge 566 of the anvil 542 along a straight sight line 568. Further, the crown 541 is positioned at and in engagement with a concave ride surface 555 on the anvil 542. The concave ride surface 555 positions the pre-hem roller 531 at a proper distance d from the hem flange line, and the alignment of the control surface 545 with the sight line 568 sets the proper flange angle. The concave ride surface 555 also maintains proper roller position while the roller 531 moves through a hemming operation. Similarly, the control surface 553 of the second pre-hem roller 533 is aligned with the anvil edge 566 along the straight sight line 568, and the crown 549 is positioned at and in engagement with a concave ride surface 555. Also, the control surface 564 of the final hem roller 534 is aligned with the anvil edge 566 along the straight sight line 568.

The cylindrical relief 543 of the first pre-hem roller 531 and the cylindrical relief 551 of the second pre-hem roller 533 compensates for variation in the width of the inner and outer panels 546, 548.

To form a rope hem between the inner and outer panels 546, 548, the robotic arm presses the first pre-hem roller 531 against the concave ride surface 555 and executes a first pass by moving the first pre-hem roller along a path in which the control surface 545 is aligned with the anvil edge 566, thereby forming a 60 degree pre-hem flange bend in the outer panel 548 (FIG. 13). The robotic arm then presses the second pre-hem roller 533 against the concave ride surface 555 and executes a second pass by moving the second pre-hem roller along a path in which the control surface 553 is aligned with the anvil edge 566, thereby forming a 30 degree pre-hem flange bend in the outer panel 548 (FIG. 14). The robotic arm then completes the rope hem by pressing the flat surface 562 of the final hem roller 534 against the outer panel 548 and executing a third pass by moving the final hem roller along a path in which the control surface 564 is aligned with the anvil edge 566 (FIG. 15).

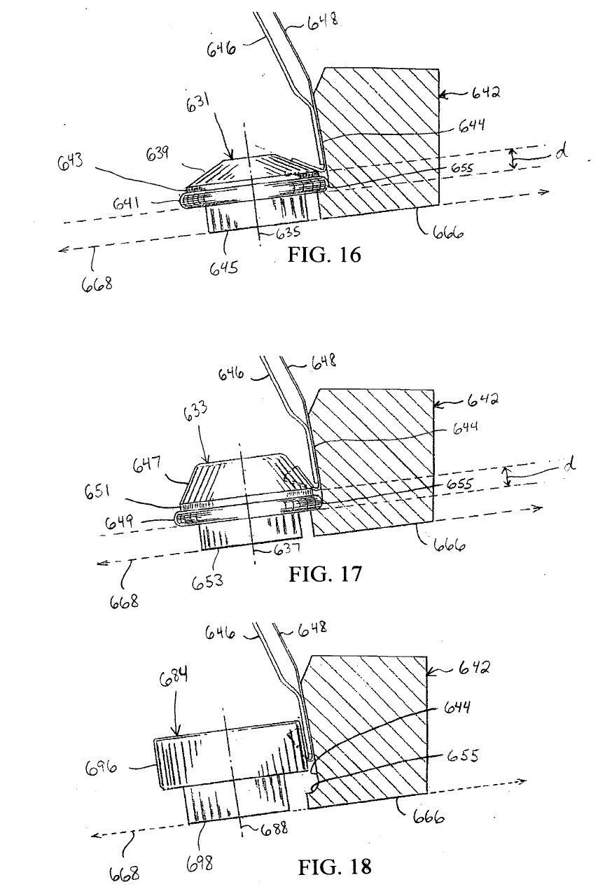

In a sixth embodiment shown in FIGS. 16 through 18, a first pre-hem roller 631, a second pre-hem roller 633, and a final hem roller 684 may be rotatably mounted about their respective axes 635, 637, 688 to a roller hemming head which is carried by a programmable multi-axis robotic arm (not shown). An anvil 642 having a support surface 644 supports an inner panel 646 and outer panel 648 for hemming.

The hem rollers 631, 633, 684 are configured for forming a flat hem in the inner and outer panels 646, 648. Each hem roller is dedicated for a specific roller hem pass. The first pre-hem roller 631 (FIG. 16) includes a 60 degree angled surface 639 for forming a 60 degree pre-hem flange bend in the outer panel 648 during a first hem pass, a crown 641 for engagement with the anvil support surface 644, a cylindrical relief 643, and a control surface 645 for aligning the roller. Similarly, the second pre-hem roller 533 (FIG. 17) includes a 30 degree angled surface 647 for forming a 30 degree pre-hem flange bend in the outer panel 648 during a second hem pass, a crown 649 for engagement with the anvil support surface 644, a cylindrical relief 651, and a control surface 653. The final hem roller 684 (FIG. 18) includes a flat surface 696 for bending the outer panel 648 against the inner panel 646 during a third hem pass, and a control surface 698.

The control surface 645 of the first pre-hem roller 631 is aligned with an edge 666 of the anvil 642 along a straight sight line 668. Further, the crown 641 is positioned at and in engagement with a concave ride surface 655 on the anvil 642. The concave ride surface 655 positions the pre-hem roller 631 at a proper distance d from the hem flange line, and the alignment of the control surface 645 with the sight line 668 sets the proper flange angle. The concave ride surface 655 also maintains proper roller position while the roller 631 moves through a hemming operation. Similarly, the control surface 653 of the second pre-hem roller 633 is aligned with the anvil edge 666 along the straight sight line 668, and the crown 649 is positioned at and in engagement with a concave ride surface 655. Also, the control surface 698 of the final hem roller 684 is aligned with the anvil edge 666 along the straight sight line 668.

The cylindrical relief 643 of the first pre-hem roller 631 and the cylindrical relief 651 of the second pre-hem roller 633 compensates for variation in the width of the inner and outer panels 646, 648.

To form a flat hem between the inner and outer panels 646, 648, the robotic arm presses the first pre-hem roller 631 against the concave ride surface 655 and executes a first pass by moving the first pre-hem roller along a path in which the control surface 645 is aligned with the anvil edge 666, thereby forming a 60 degree pre-hem flange bend in the outer panel 648 (FIG. 16). The robotic arm then presses the second pre-hem roller 633 against the concave ride surface 655 and executes a second pass by moving the second pre-hem roller along a path in which the control surface 653 is aligned with the anvil edge 666, thereby forming a 30 degree pre-hem flange bend in the outer panel 648 (FIG. 17). The robotic arm then completes the flat hem by pressing the flat surface 696 of the final hem roller 684 against the outer panel 648 and executing a third pass by moving the final hem roller along a path in which the control surface 698 is aligned with the anvil edge 666 (FIG. 18).

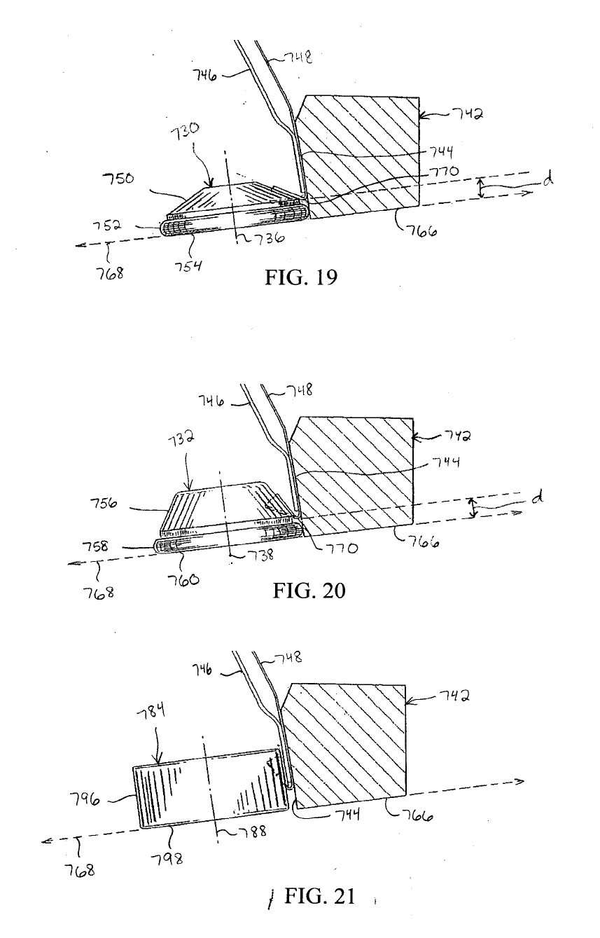

In a seventh embodiment shown in FIGS. 19 through 21, a first pre-hem roller 730, a second pre-hem roller 732, and a final hem roller 784 may be rotatably mounted about their respective axes 736, 738, 788 to a roller hemming head which is carried by a programmable multi-axis robotic arm (not shown). An anvil 742 having a support surface 744 supports an inner panel 746 and outer panel 748 for hemming.

The hem rollers 730, 732, 784 are configured for forming a flat hem in the inner and outer panels 746, 748. Each hem roller is dedicated for a specific roller hem pass. The first pre-hem roller 730 (FIG. 19) includes a 60 degree angled surface 750 for forming a 60 degree pre-hem flange bend in the outer panel 748 during a first hem pass, a crown 752 for engagement with the anvil support surface 744, and a control surface 754 for aligning the roller. Similarly, the second pre-hem roller 732 (FIG. 20) includes a 30 degree angled surface 756 for forming a 30 degree pre-hem flange bend in the outer panel 748 during a second hem pass, a crown 758 for engagement with the anvil support surface 744, and a control surface 760. The final hem roller 784 (FIG. 21) includes a flat surface 796 for bending the outer panel 748 against the inner panel 746 during a third hem pass, and a control surface 798.

The control surface 754 of the first pre-hem roller 730 is aligned with an edge 766 of the anvil 742 along a straight sight line 768. The alignment of the control surface 754 with the anvil edge 766 controls the distance d between the anvil edge 766 and the hem flange bend 770 in the outer panel 748, thereby determining the position of the hem flange line. To adjust the position of the hem flange line, the first pre-hem roller 730 is moved axially along its axis 736 generally parallel to the anvil surface 744, which in turn varies the position of the roller's angled hemming surface 750 relative to the outer panel 748. Similarly, the control surface 760 of the second pre-hem roller 732 is aligned with the anvil edge 766 along the straight sight line 768, and the control surface 798 of the final hem roller 784 is aligned with the anvil edge 744 along the straight sight line 768.

To form a flat hem between the inner and outer panels 746, 748, the robotic arm presses the first pre-hem roller 730 against the anvil support surface 744 and executes a first pass by moving the first pre-hem roller along a path in which the control surface 754 is aligned with the anvil edge 766, thereby forming a 60 degree pre-hem flange bend in the outer panel (FIG. 19). The robotic arm then presses the second pre-hem roller 732 against the anvil support surface 744 and executes a second pass by moving the second pre-hem roller along a path in which the control surface 760 is aligned with the anvil edge 766, thereby forming a 30 degree pre-hem flange bend in the outer panel (FIG. 20). The robotic arm then completes the flat hem by pressing the flat surface 796 of the final hem roller 784 against the outer panel 748 and executing a third pass by moving the final hem roller along a path in which the control surface 794 is aligned with the anvil edge 766 (FIG. 21).

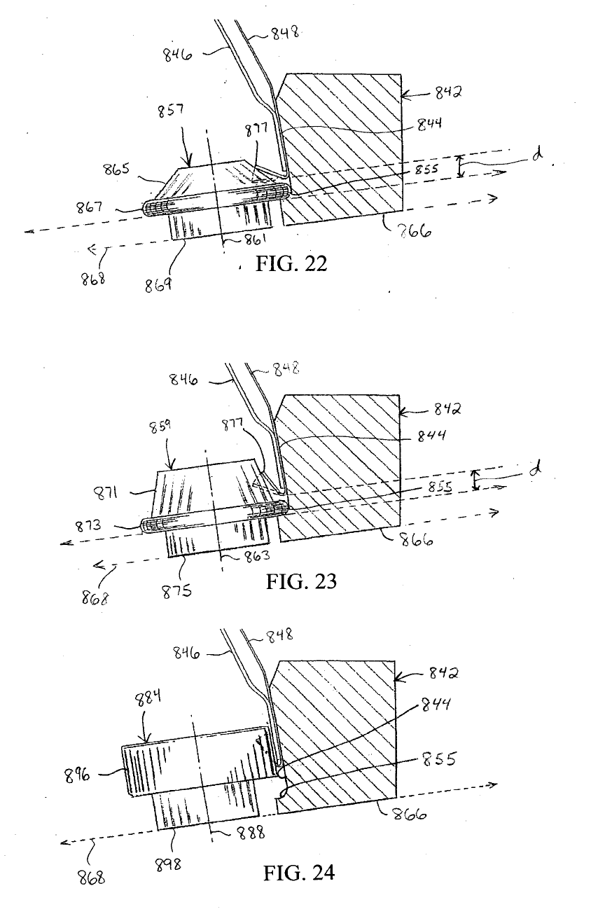

In a eighth embodiment shown in FIGS. 22 through 24, a first pre-hem roller 857, a second pre-hem roller 859, and a final hem roller 884 may be rotatably mounted about their respective axes 861, 863, 888 to a roller hemming head which is carried by a programmable multi-axis robotic arm (not shown). An anvil 842 having a support surface 844 supports an inner panel 846 and outer panel 848 for hemming.

The hem rollers 857, 859, 884 are configured for forming a flat hem in the inner and outer panels 846, 848. Each hem roller is dedicated for a specific roller hem pass. The first pre-hem roller 857 (FIG. 22) includes an angled surface 865 for forming a pre-hem flange bend in the outer panel 848 during a first hem pass, a crown 867 for engagement with the anvil support surface 844, and a control surface 869 for aligning the roller. The angle of the angled surface 865 is set approximately 15 degrees less than the flange angle requirement for the first hem pass. Similarly, the second pre-hem roller 859 (FIG. 23) includes an angled surface 871 for forming a pre-hem flange bend in the outer panel 848 during a second hem pass, a crown 873 for engagement with the anvil support surface 844, and a control surface 875. The angle of the angled surface 871 is set approximately 15 degrees less than the flange angle requirement for the second hem pass. The final hem roller 884 (FIG. 24) includes a flat surface 896 for bending the outer panel 848 against the inner panel 846 during a third hem pass, and a control surface 898.

The control surface 869 of the first pre-hem roller 857 is aligned with an edge 866 of the anvil 842 along a straight sight line 868. Further, the crown 867 is positioned at and in engagement with a concave ride surface 855 on the anvil 842. The concave ride surface 855 positions the pre-hem roller 857 at a proper distance d from the hem flange line. The concave ride surface 855 and the sight line 868 maintain proper roller position while the roller 857 moves through a hemming operation. Similarly, the control surface 875 of the second pre-hem roller 859 is aligned with the anvil edge 866 along the straight sight line 868, and the crown 873 is positioned at and in engagement with a concave ride surface 855. Also, the control surface 898 of the final hem roller 884 is aligned with the anvil edge 866 along the straight sight line 868.

When the first pre-hem roller 857 is aligned with the concave ride surface 855 and the sight line 868, the angled surface 865 of the roller only contacts the hem flange at the end 877 of the outer panel 848. Similarly, when the second pre-hem roller 859 is aligned with the concave ride surface 855 and the sight line 868, the angle surface 871 of the roller only contacts the hem flange at the end 877 of the outer panel 848. Therefore, variation in the width of the inner and outer panels 846, 848 does not affect the hem flange line or hem flange angle, and no reprogramming of the roller path is required.

To form a flat hem between the inner and outer panels 846, 848, the robotic arm presses the first pre-hem roller 857 against the concave ride surface 855 and executes a first pass by moving the first pre-hem roller along a path in which the control surface 869 is aligned with the anvil edge 866, thereby forming a 60 degree pre-hem flange bend in the outer panel 848 (FIG. 22). The robotic arm then presses the second pre-hem roller 859 against the concave ride surface 855 and executes a second pass by moving the second pre-hem roller along a path in which the control surface 875 is aligned with the anvil edge 866, thereby forming a 30 degree pre-hem flange bend in the outer panel 848 (FIG. 23). The robotic arm then completes the flat hem by pressing the flat surface 896 of the final hem roller 884 against the outer panel 848 and executing a third pass by moving the final hem roller along a path in which the control surface 898 is aligned with the anvil edge 866 (FIG. 24).

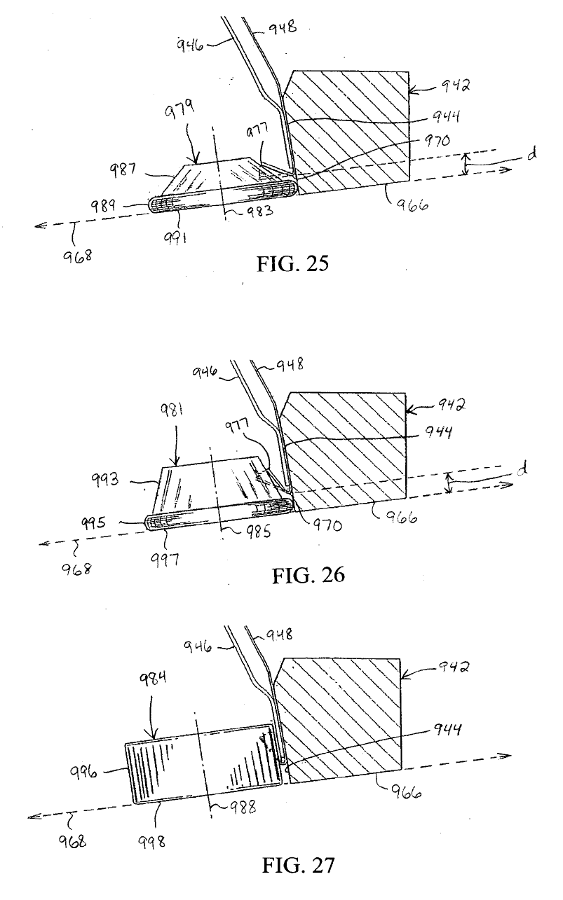

In a ninth embodiment shown in FIGS. 25 through 27, a first pre-hem roller 979, a second pre-hem roller 981, and a final hem roller 984 may be rotatably mounted about their respective axes 983, 985, 988 to a roller hemming head which is carried by a programmable multi-axis robotic arm (not shown). An anvil 942 having a support surface 944 supports an inner panel 946 and outer panel 948 for hemming.

The hem rollers 979, 981, 984 are configured for forming a flat hem in the inner and outer panels 946, 948. Each hem roller is dedicated for a specific roller hem pass. The first pre-hem roller 979 (FIG. 25) includes an angled surface 987 for forming a pre-hem flange bend in the outer panel 948 during a first hem pass, a crown 989 for engagement with the anvil support surface 944, and a control surface 991 for aligning the roller. The angle of the angled surface 987 is set approximately 15 degrees less than the flange angle requirement for the first hem pass. Similarly, the second pre-hem roller 981 (FIG. 26) includes an angled surface 993 for forming a pre-hem flange bend in the outer panel 948 during a second hem pass, a crown 995 for engagement with the anvil support surface 944, and a control surface 997. The angle of the angled surface 993 is set approximately 15 degrees less than the flange angle requirement for the second hem pass. The final hem roller 984 (FIG. 27) includes a flat surface 996 for bending the outer panel 948 against the inner panel 946 during a third hem pass, and a control surface 998.

The control surface 991 of the first pre-hem roller 979 is aligned with an edge 966 of the anvil 942 along a straight sight line 968. The alignment of the control surface 991 with the anvil edge 966 controls the distance d between the anvil edge 966 and the hem flange bend 970 in the outer panel 948, thereby maintaining an even hemming path. Similarly, the control surface 997 of the second pre-hem roller 981 is aligned with the anvil edge 966 along the straight sight line 968, and the control surface 998 of the final hem roller 984 is aligned with the anvil edge 966 along the straight sight line 968.

When the first pre-hem roller 979 is aligned with the sight line 968, the angled surface 987 of the roller only contacts the hem flange at the end 977 of the outer panel 948. Similarly, when the second pre-hem roller 981 is aligned with the sight line 968, the angle surface 993 of the roller only contacts the hem flange at the end 977 of the outer panel 948. Therefore, variation in the width of the inner and outer panels 946, 948 does not affect the hem flange line or hem flange angle, and no reprogramming of the roller path is required.

To form a flat hem between the inner and outer panels 946, 948, the robotic arm presses the first pre-hem roller 979 against the anvil support surface 944 and executes a first pass by moving the first pre-hem roller along a path in which the control surface 991 is aligned with the anvil edge 966, thereby forming a 60 degree pre-hem flange bend in the outer panel 948 (FIG. 25). The robotic arm then presses the second pre-hem roller 981 against the anvil support surface 944 and executes a second pass by moving the second pre-hem roller along a path in which the control surface 997 is aligned with the anvil edge 966, thereby forming a 30 degree pre-hem flange bend in the outer panel 948 (FIG. 26). The robotic arm then completes the flat hem by pressing the flat surface 996 of the final hem roller 984 against the outer panel 948 and executing a third pass by moving the final hem roller along a path in which the control surface 998 is aligned with the anvil edge 966 (FIG. 27).

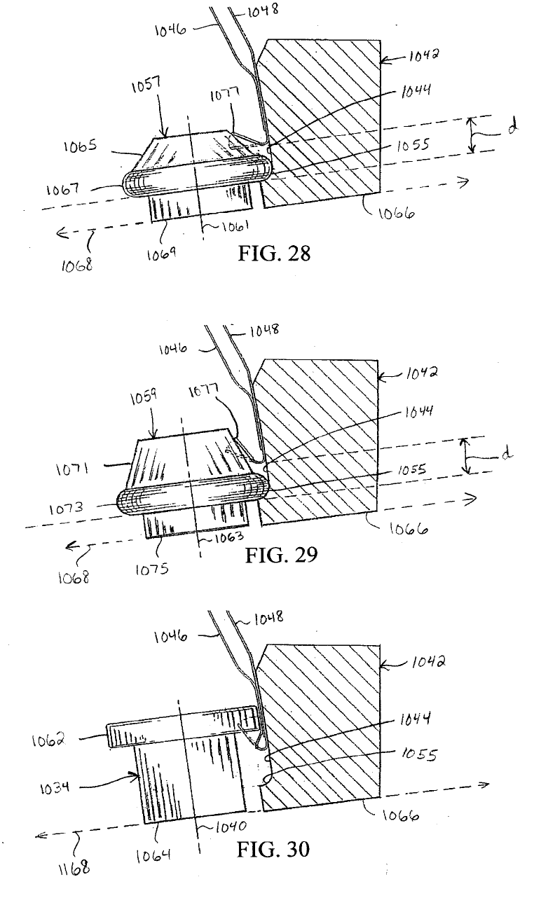

In a tenth embodiment shown in FIGS. 28 through 30, a first pre-hem roller 1057, a second pre-hem roller 1059, and a final hem roller 1034 may be rotatably mounted about their respective axes 1061, 1063, 1040 to a roller hemming head which is carried by a programmable multi-axis robotic arm (not shown). An anvil 1042 having a support surface 1044 supports an inner panel 1046 and outer panel 1048 for hemming.

The hem rollers 1057, 1059, 1034 are configured for forming a rope hem in the inner and outer panels 1046, 1048. Each hem roller is dedicated for a specific roller hem pass. The first pre-hem roller 1057 (FIG. 28) includes an angled surface 1065 for forming a pre-hem flange bend in the outer panel 1048 during a first hem pass, a crown 1067 for engagement with the anvil support surface 1044, and a control surface 1069 for aligning the roller. The angle of the angled surface 1065 is set approximately 15 degrees less than the flange angle requirement for the first hem pass. Similarly, the second pre-hem roller 1059 (FIG. 29) includes an angled surface 1071 for forming a pre-hem flange bend in the outer panel 1048 during a second hem pass, a crown 1073 for engagement with the anvil support surface 1044, and a control surface 1075. The angle of the angled surface 1071 is set approximately 15 degrees less than the flange angle requirement for the second hem pass. The final hem roller 1034 (FIG. 30) includes a flat surface 1062 for bending the outer panel 1048 against the inner panel 1046 during a third hem pass, and a control surface 1064.

The control surface 1069 of the first pre-hem roller 1057 is aligned with an edge 1066 of the anvil 1042 along a straight sight line 1068. Further, the crown 1067 is positioned at and in engagement with a concave ride surface 1055 on the anvil 1042. The concave ride surface 1055 positions the pre-hem roller 1057 at a proper distance d from the hem flange line. The concave ride surface 1055 and the sight line 1068 maintain proper roller position while the roller 1057 moves through a hemming operation. Similarly, the control surface 1075 of the second pre-hem roller 1059 is aligned with the anvil edge 1066 along the straight sight line 1068, and the crown 1073 is positioned at and in engagement with a concave ride surface 1055. Also, the control surface 1064 of the final hem roller 1034 is aligned with the anvil edge 1066 along the straight sight line 1068.

When the first pre-hem roller 1057 is aligned with the concave ride surface 1055 and the sight line 1068, the angled surface 1065 of the roller only contacts the hem flange at the end 1077 of the outer panel 1048. Similarly, when the second pre-hem roller 1059 is aligned with the concave ride surface 1055 and the sight line 1068, the angle surface 1071 of the roller only contacts the hem flange at the end 1077 of the outer panel 1048. Therefore, variation in the width of the inner and outer panels 1046, 1048 does not affect the hem flange line or hem flange angle, and no reprogramming of the roller path is required.

To form a rope hem between the inner and outer panels 1046, 1048, the robotic arm presses the first pre-hem roller 1057 against the concave ride surface 1055 and executes a first pass by moving the first pre-hem roller along a path in which the control surface 1069 is aligned with the anvil edge 1066, thereby forming a 60 degree pre-hem flange bend in the outer panel 1048 (FIG. 28). The robotic arm then presses the second pre-hem roller 1059 against the concave ride surface 1055 and executes a second pass by moving the second pre-hem roller along a path in which the control surface 1075 is aligned with the anvil edge 1066, thereby forming a 30 degree pre-hem flange bend in the outer panel 1048 (FIG. 29). The robotic arm then completes the flat hem by pressing the flat surface 1096 of the final hem roller 1034 against the outer panel 1048 and executing a third pass by moving the final hem roller along a path in which the control surface 1064 is aligned with the anvil edge 1066 (FIG. 30).

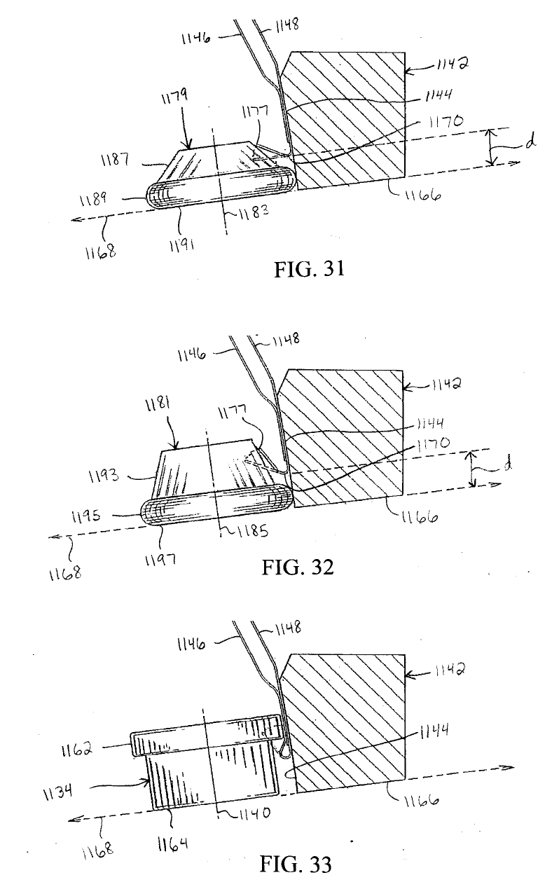

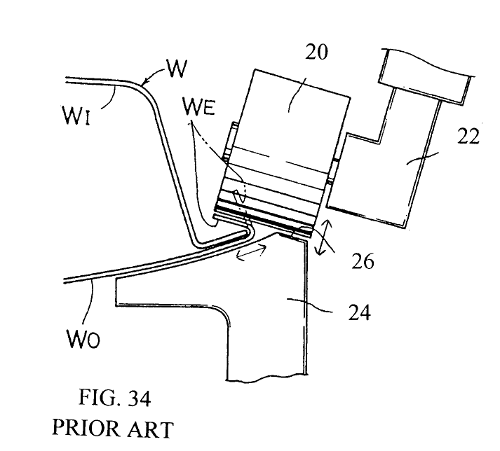

In an eleventh embodiment shown in FIGS. 31 through 33, a first pre-hem roller 1179, a second pre-hem roller 1181, and a final hem roller 1134 may be rotatably mounted about their respective axes 1183, 1185, 1140 to a roller hemming head which is carried by a programmable multi-axis robotic arm (not shown). An anvil 1142 having a support surface 1144 supports an inner panel 1146 and outer panel 1148 for hemming.

The hem rollers 1179, 1181, 1134 are configured for forming a rope hem in the inner and outer panels 1146, 1148. Each hem roller is dedicated for a specific roller hem pass. The first pre-hem roller 1179 (FIG. 31) includes an angled surface 1187 for forming a pre-hem flange bend in the outer panel 1148 during a first hem pass, a crown 1189 for engagement with the anvil support surface 1144, and a control surface 1191 for aligning the roller. The angle of the angled surface 1187 is set approximately 15 degrees less than the flange angle requirement for the first hem pass. Similarly, the second pre-hem roller 1181 (FIG. 32) includes an angled surface 1193 for forming a pre-hem flange bend in the outer panel 1148 during a second hem pass, a crown 1195 for engagement with the anvil support surface 1144, and a control surface 1197. The angle of the angled surface 1193 is set approximately 15 degrees less than the flange angle requirement for the second hem pass. The final hem roller 1134 (FIG. 33) includes a flat surface 1162 for bending the outer panel 1148 against the inner panel 1146 during a third hem pass, and a control surface 1164.

The control surface 1191 of the first pre-hem roller 1179 is aligned with an edge 1166 of the anvil 1142 along a straight sight line 1168. The alignment of the control surface 1191 with the anvil edge 1166 controls the distance d between the anvil edge 1166 and the hem flange bend 1170 in the outer panel 1148, thereby maintaining an even hemming path. Similarly, the control surface 1197 of the second pre-hem roller 1181 is aligned with the anvil edge 1166 along the straight sight line 1168, and the control surface 1164 of the final hem roller 1134 is aligned with the anvil edge 1166 along the straight sight line 1168.

When the first pre-hem roller 1179 is aligned with the sight line 1168, the angled surface 1187 of the roller only contacts the hem flange at the end 1177 of the outer panel 1148. Similarly, when the second pre-hem roller 1181 is aligned with the sight line 1168, the angle surface 1193 of the roller only contacts the hem flange at the end 1177 of the outer panel 1148. Therefore, variation in the width of the inner and outer panels 1146, 1148 does not affect the hem flange line or hem flange angle, and no reprogramming of the roller path is required.

To form a rope hem between the inner and outer panels 1146, 1148, the robotic arm presses the first pre-hem roller 1179 against the anvil support surface 1144 and executes a first pass by moving the first pre-hem roller along a path in which the control surface 1191 is aligned with the anvil edge 1166, thereby forming a 60 degree pre-hem flange bend in the outer panel 1148 (FIG. 31). The robotic arm then presses the second pre-hem roller 1181 against the anvil support surface 1144 and executes a second pass by moving the second pre-hem roller along a path in which the control surface 1197 is aligned with the anvil edge 1166, thereby forming a 30 degree pre-hem flange bend in the outer panel 1148 (FIG. 32). The robotic arm then completes the rope hem by pressing the flat surface 1162 of the final hem roller 1134 against the outer panel 1148 and executing a third pass by moving the final hem roller along a path in which the control surface 1164 is aligned with the anvil edge 1166 (FIG. 33).

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. A method of roller hemming an inner panel and an outer panel, said method comprising the steps of:
providing a hem roller having an angled roller hemming surface; and
adjusting a hem flange line by moving said hem roller axially and generally parallel to an anvil support surface of an anvil.

2. A method of roller hemming comprising the steps of:
disposing an inner panel and an outer panel on said support surface of said anvil;
performing pre-hem operations including:
aligning a control surface of a pre-hem roller with an edge of said anvil along a sight line defined by said anvil edge by moving said pre-hem roller axially along its axis and generally parallel to said anvil support surface, whereby a location of a hem flange line extending from an angular bend in said outer panel is set; and
rotating said pre-hem roller along said anvil support surface in alignment with said sight line such that said angled roller hemming surface of said pre-hem roller contacts said outer panel to form an angled pre-hem bend in said outer panel;
performing final hem operations including:
aligning a control surface of a final hem roller with said anvil edge along said sight line by moving said final hem roller axially along its axis and generally parallel to said anvil support surface; and
rotating said final hem roller along said anvil support surface in alignment with said sight line such that said final hem roller contacts said outer panel to form a final hem between said inner and outer panels.

3. The method of claim 2, wherein said pre-hem operations include:
aligning a control surface of a first pre-hem roller with an edge of said anvil along a sight line defined by said anvil edge by moving said first pre-hem roller axially along its axis and generally parallel to said anvil support surface, whereby a location of a hem flange line extending from an angular bend in said outer panel is set;
rotating said first pre-hem roller along said anvil support surface in alignment with said sight line to form an angled pre-hem bend in said outer panel;
aligning a control surface of a second pre-hem roller with an edge of said anvil along a sight line defined by said anvil edge by moving said pre-hem roller axially along its axis and generally parallel to said anvil support surface, whereby a location of a hem flange line extending from an angular bend in said outer panel is set; and
rotating said second pre-hem roller along said anvil support surface in alignment with said sight line to form an angled pre-hem bend in said outer panel.

4. The method of claim 2, wherein said pre-hem operations include:
aligning a control surface of a pre-hem roller with an edge of said anvil along a sight line defined by said anvil edge by moving said pre-hem roller axially along its axis and generally parallel to said anvil support surface, whereby a location of a hem flange line extending from an angular bend in said outer panel is set;
pivoting said pre-hem roller about a crown of said pre-hem roller to adjust the disposition of a angled surface of said pre-hem roller relative to said anvil support surface;
rotating said pre-hem roller along said anvil support surface to form an angled pre-hem bend in said outer panel;
pivoting said pre-hem roller about said crown to align said control surface of said pre-hem roller with said anvil edge; and
rotating said pre-hem roller along said anvil support surface in alignment with said sight line to form an angled pre-hem bend in said outer panel.

5. The method of claim 2, wherein a rope hem is formed between said inner and outer panels.

6. The method of claim 2, wherein a flat hem is formed between said inner and outer panels.

7. The method of claim 2, wherein said angled roller hemming surface of said pre-hem roller only contacts an end of said outer panel such that variation in the width of said inner and outer panels does not affect said hem flange line.

8. The method of claim 1, wherein said anvil includes a concave ride surface and said roller includes a crown cooperable with said concave ride surface, said method further including the step of engaging said crown with said concave ride surface to control the position of said roller relative to said hem flange line.

9. The method of claim 1, wherein said roller includes a cylindrical relief adjacent said angled roller hemming surface, said cylindrical relief compensating for variation in the width of said inner and outer panels and eliminating repositioning of said roller if said panels increase or decrease in width.

10. An apparatus for roller hemming an inner panel and an outer panel, said apparatus comprising:
an anvil having a support surface for supporting said inner and outer panels and an edge adjacent said support surface;
a hem roller rotatable about an axis and having a roller hem surface for engaging said outer panel to effect a hem operation and a control surface for aligning said hem roller;
said control surface being aligned with said anvil edge by moving said hem roller axially along said axis and generally parallel to said anvil support surface.

11. The roller hemming apparatus of claim 10, wherein said hem roller surface for engaging said outer panel is an angled surface for effecting a pre-hem bend in said outer panel.

12. The roller hemming apparatus of claim 11, wherein said angled surface is a generally 30 degree angled surface.

13. The roller hemming apparatus of claim 11, wherein said angled surface is a generally 60 degree angled surface.

14. The roller hemming apparatus of claim 11, wherein said angled surface only contacts an end of said outer panel such that variation in the width of said inner and outer panels does not affect a hem flange line of said outer panel or hem flange angle of said outer panel.

15. The roller hemming apparatus of claim 10, wherein said hem roller surface for engaging said outer panel is a flat surface for effecting a final hem bend in said outer panel.

16. The roller hemming apparatus of claim 10, wherein said roller includes a crown engagable with said anvil support surface, said roller being pivotable about said crown relative to said anvil support surface.

17. The roller hemming apparatus of claim 10, wherein said anvil includes a concave ride surface, and said roller includes a crown cooperable with said concave ride surface, said concave ride surface controlling the position of said roller relative to a hem flange line of said outer panel.

18. The roller hemming apparatus of claim 10, wherein said roller includes a cylindrical relief adjacent said roller hem surface, said cylindrical relief eliminating repositioning of said roller if said panels increase or decrease in width.
